(19) United States
(12) Patent Application Publication
(10) Pub. No.: US 2014/0373106 A1
(43) Pub. Date: Dec. 18, 2014

(54) Handling Emails

(71) Applicant: Lee Hayes Morgenroth, New York, NY (US)

(72) Inventor: Lee Hayes Morgenroth, New York, NY (US)

(21) Appl. No.: 14/344,889

(22) PCT Filed: Sep. 13, 2012
(86) PCT No.: PCT/GB2012/052267

§ 371 Date: Mar. 13, 2014

(30) Foreign Application Priority Data
Sep. 13, 2011 (GB) 1115794.8

(51) Int. Cl. H04L 29/06; H04L 12/58

(52) U.S. Cl. CPC H04L 63/126; H04L 51/12
USPC 726/4

(57) ABSTRACT

Disclosed are various methods for handling emails. They involve including email addresses in envelope recipient and envelope sender fields that are different to the addresses that would normally be included. One method comprises: receiving an email message at a service provider, the email message having in an envelope sender field a sender's email address relating to an unprotected sending contact entity and in an envelope recipient field a receiving alias email address relating to a protected receiving contact entity; wherein the recipient's email address includes a domain that is controlled by the service provider such that the email message is addressed to the protected receiving contact entity via the service provider, identifying a database record containing the recipient's email address; extracting from the database record a protected entity delivery email address for the protected receiving contact entity; substituting the recipient's email address in the envelope recipient field of the email message with the protected entity delivery email address; and providing the email message with the substituted envelope recipient email address.

### FIELD OF THE INVENTION

The present invention is in the technical field of communications, and in particular to handling emails. In particular, although not exclusively, the present invention relates to identity management and email addressing.

### SUMMARY OF THE INVENTION

In a first aspect, the present invention features a method for creating an alias identity for a protected entity to be used for communication with a specific entity. This method comprises the step of using an identifier for the specific entity to generate an alias identity for the protected entity to conduct the communications.

In another aspect of the invention a method for recalling an alias identity by a protected entity for a specific entity is provided. The method comprises the step of using the identifier used to generate the alias identity as a token to recall the alias identity by the protected entity.

In another aspect of the invention a system for maintaining each alias identity for each specific entity by a protected entity is provided. The system comprises an identity server for storing, verifying, retrieving, and resolving alias identities; and an identity client interface for creating, reading, updating, and deleting alias identities.

In another aspect of the invention an improved communication contact address for an alias identity is provided. The improved communication contact address comprises two address aliases, the first an alias for the specific entity to use to send communication to the protected entity, and a second for the protected entity to use to send communication to the specific entity.

In another aspect of the invention a system for delivering communications to a protected entity without the sender knowing the communication delivery address of the protected entity is provided. The system comprises one or a plurality of privileged communications servers for receiving communications addressed to an improved communication contact address for an alias identity, confirming the authorization of the sender, querying the identity server to verify the alias identity and resolving the contact address to the delivery address of the protected entity, and delivering the communication to the delivery address of the protected entity.

In another aspect of the invention a system for sending communications from the protected entity to specific entities without disclosing the true identity of the protected entity is provided. The system comprises a privileged communications server for receiving the communications from the protected entity addressed to the improved communication contact addresses. The privileged communication server confirms the authorization of the sender, queries the identity server to determine the correct alias identity to use as the visible sender of the communication and resolves the delivery address for each specific communication recipient.

### BRIEF DESCRIPTION OF THE DRAWINGS

FIG. 1A is a diagram of a conventional email address;

FIG. 1B is a diagram of a contact receiving alias according to an embodiment of the present invention;

FIG. 1C is a diagram of a contact sending alias according to an embodiment of the present invention;

FIG. 2 is a block diagram illustrating a system configured according to an embodiment of the present invention;

FIG. 3 is a diagram illustrating a database used in connection with the system shown in FIG. 2;

FIG. 4 is a diagram illustrating the process of address transformation receiving a message in an embodiment of the present invention;

FIG. 5 is a diagram illustrating the process of address transformation sending a message in an embodiment of the present invention;

FIG. 6 is a diagram illustrating the process of address transformation sending and receiving a message in an embodiment of the present invention;

FIG. 7 is a flow diagram illustrating the process of processing an email message addressed to a receiving alias according to an embodiment of the present invention;

FIG. 8 is a flow diagram illustrating the process of processing an email message addressed to a sending alias according to an embodiment of the present invention;

FIG. 9 is a block diagram illustrating a system configured to an alternative embodiment of the present invention;

FIG. 10a is a diagram illustrating a user interface for creating a contact in an embodiment of the present invention;

FIG. 10b is a diagram illustrating a user interface for editing a contact in an embodiment of the present invention;

FIG. 10c is a diagram illustrating a user interface for editing a contact in an embodiment of the present invention;

FIG. 11 is a diagram illustrating the process of address transformation receiving a message in an alternative embodiment of the present invention;

FIG. 12 is a diagram illustrating the process of address transformation sending a message in an alternative embodiment of the present invention; and

FIG. 13 is a diagram illustrating the process of address transformation sending and receiving a message in an alternative embodiment of the present invention.

### DETAILED DESCRIPTION OF THE INVENTION

In the drawings, like reference numerals refer to like elements throughout.

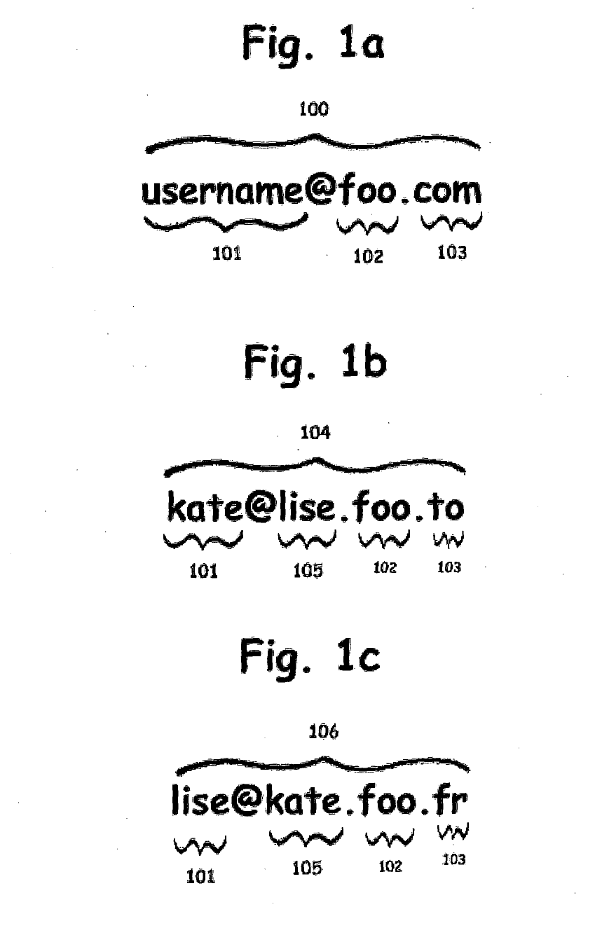

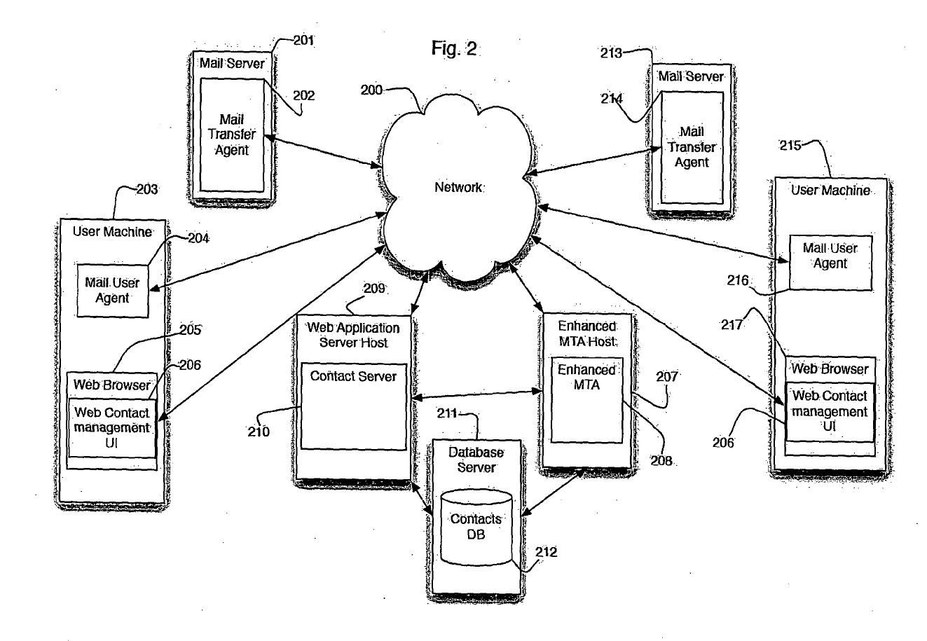

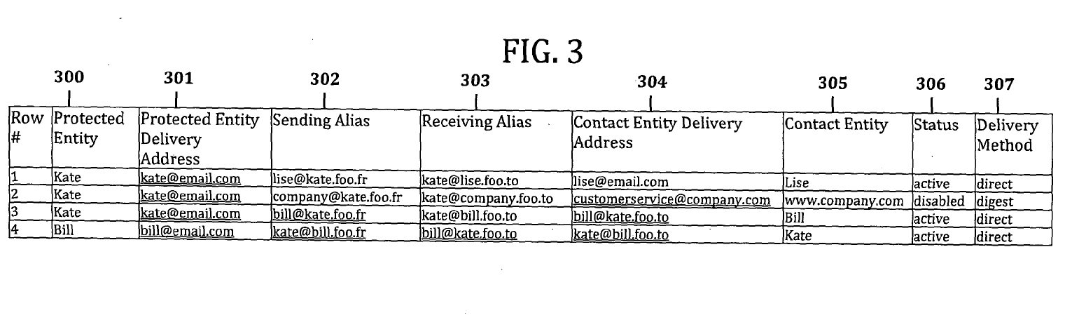

Referring now to the invention in more detail, in FIG. 1a there is shown a prior art conventional email address 100. This email address is in the standard Internet domain format. The format usually consists of a hierarchy of names, the top level domain (TLD) name 103 being of a highest level, the second level domain (SLD) name 102 being of a lower level, and the user name 101 being of the lowest level in the hierarchy. Between the user name 101 and the SLD 102 is an “at” sign, “@”. There is a dot (“.”) between the SLD 102 and the TLD 103. The user name 101 typically refers to the owner of the email address, or the entity to which messages sent to this email address 100 are delivered. The combination of the SLD 102, the dot (“.”), and the TLD 103 form the domain name and typically refer to the Internet domain or internet server where the user's email account is hosted.

Referring now FIG. 1b there is shown an email “receiving alias” 104 used in embodiments of the invention. This email address is in the standard Internet domain format. This format usually consists of a hierarchy of names, the domain name being of a higher level and the user name being of a lower level in the hierarchy. It should be known that other known address formats may also be used. Indeed, virtually any address format that identifies an individual user may be used.

The receiving alias 104 in FIG. 1b comprises at least four basic parts, the user name 101, the sub-domain name 105, and the SLD 102 and the TLD 103. Between the user name 101 and the sub-domain name 106 is an “at” sign, “@”. As shown in FIG. 1b there is a dot (“.”) between the sub domain name 105 and the SLD 102 and between the SLD 102 and the TLD 103. By comparison of FIG. 1a and FIG. 1b, it should be noticed that the prior art address (FIG. 1a) is somewhat similar in appearance to the receiving alias of the embodiment of FIG. 1b, except that the receiving alias of this embodiment contains the sub-domain name 105 to the right of the “at” sign. Thus the receiving alias 104 contains both the traditional address information (e.g. user name 105, SLD 102, and TLD 103), as well as the sub-domain name 105. It should be noted that traditional addresses may also contain a sub-domain name. However in a traditional email address the sub-domain typically identifies a mail server machine. In the current invention the sub-domain is used to identify the message sender. In the illustrated version of a receiving alias 104 the TLD 103, in this case “.to”, is used to indicate that this address is a receiving alias, or in other words used to address a message to a system user. The use of the TLD as an indicator is optional, and it will be understood that any TLD may be used.

The sending alias 106 in FIG. 1c comprises at least four basic parts, the user name 101, the sub-domain name 105, the SLD 102, and the TLD 103. Between the user name 101 and the sub-domain name 105 is an “at” sign, “@”. As shown in FIG. 1c there is a dot (“.”) between the sub domain name 105, the SLD 102, and the TLD 103. By comparison of FIG. 1a and FIG. 1c, it should be noticed that the prior art address (FIG. 1a) is somewhat similar in appearance to the sending alias of the embodiment of FIG. 1c, except that the sending alias of this embodiment contains the sub-domain name 105 to the right of the “at” sign. Thus the sending alias 106 contains both the traditional address information (e.g. user name 101, SLD 102, and TLD 103), as well as the sub-domain name 105. It should be noted that traditional addresses may also contain a sub-domain name. However in a traditional email address the sub-domain typically identifies a mail server machine. In the current invention the sub-domain is used to identify the message sender. By comparison of FIG. 1b and FIG. 1c, it should be noticed that the embodiment of the receiving alias in FIG. 1b is somewhat similar in appearance to the embodiment of the sending alias in FIG. 1c, except that the sub-domain names 105 and the TLDs 103 differ in the sending alias and the receiving alias. In this example of a sending alias 106 the TLD 103 “fr” is used to indicate that this address is a sending alias, or in other words is used by users of the system to send messages. The use of a specific TLD as an indicator is optional, and it will be understood that any hostname may be used, and that the same TLD may be used for both sending aliases and receiving aliases.

In some embodiments, the receiving aliases 104 and sending aliases 106 are managed as part of a “contact” which is described below in detail with respect to other functions it performs.

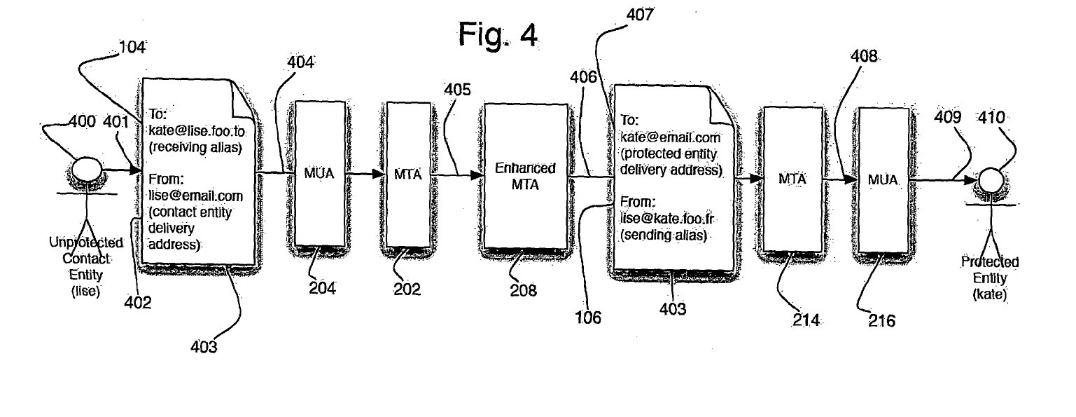

Referring now to FIG. 2 the architecture for an embodiment implementing the system is shown. The hardware involved is connected to a network 200 for sending and receiving messages. This network may be the Internet, or any other network capable of sending messages. Connected to the network 200 are mail servers 201 and 213. In some embodiments, these can be implemented with Quad-Core AMD Opteron servers with two gigabytes of RAM running the Linux operating system. The system may function using only a single mail server such as 201, but multiple servers have been shown for clarity. Within servers 201 and 213 are a mail transfer agents 202 and 214 respectively. The mail transfer agents 202 and 214 can be implemented using mail server software such as Postfix. It will be understood, however, that other suitable computers and software may be used as the mail transfer agent servers and mail transfer agent software. It will be understood that a cluster of mail servers using the same or different hardware and software may be used.

The mail server 201 is accessed via the network 200 by a user machine 203, and mail server 213 is accessed via the network 200 by user machine 215 In some embodiments the user machines 203 and 215 may each be implemented with a personal computer, for example an Acer Aspire 1410 with two gigabytes of RAM running the Windows 7 operating system from Microsoft. It will be understood that other suitable computers or devices such as mobile phones or tablet computers, may be used for the user machines 203 and 215. It will be understood that user machines 203 and 215 may also access the same server such as 201 via the network 200 and it would have no negative impact on the system.

The user machines 203 and 215 act as hosts for the mail user agents (MUA) 204 and 216 respectively, which are used by users to send and receive messages. In some embodiments the mail user agents 204 and 216 may be implemented using the Thunderbird open source mail user agent software. It will be understood that other software may be used as the mail user agent. It will be understood that the function of the mail user agent may be served through a web interface via a web-mail program such as Gmail or Hotmail and it would have no negative impact on the system.

Within the user machines 203 and 215 are web browsers 205 and 217 respectively. In some embodiments the web browsers 205 and 217 may be implemented with the Firefox open source browser. The web browsers 205 and 217 are used to view and administer the contact database and contact management system via the web contact management UI 206.

Also connected to the network 200 is an enhanced mail transfer agent server host 207. In some embodiments, this can be implemented with a cloud based Quad-Core AMD Opteron server with two gigabytes of RAM running the Linux operating system. It will be understood, however, that other suitable computers, or clusters of computers, can be used as the enhanced mail transfer agent server host. The enhanced mail transfer agent server host 207 acts as a host for the enhanced mail transfer agent 208. The enhanced mail transfer agent may be implemented through configuration of and integration with the Postfix server, and software code written, for example in the Ruby language. It is also understood that the enhanced mail transfer agent 208 may alternatively be implemented using other software languages, other mail transfer agent server software, or without pre-existing mail transfer agent server software, or in a combination of software and hardware.

The web application server host 209 is connected to the improved MTA host 207. In some embodiments the web application server host 209 may be implemented using a cloud based Quad-Core AMD Opteron server with two gigabytes of RAM running the Linux operating system such as those provided by the Amazon Elastic Compute Cloud. It will be understood, however, that other suitable computers, or cluster of computers, may be used as the server. It will be understood that the web application server host 209 may be connected to the improved MTA host 207 through the network 200, or through an independent private network.

The web application server host 209 acts as a host for the contacts server 210. In some embodiments the web application server host 209 may be implemented with a cloud based Quad-Core AMD Opteron server with two gigabytes of RAM running the Linux operating system such as instances of the Amazon Elastic Compute Cloud. It will be understood, however, another suitable computer or cluster of computers may be used to implement the web application server host 209. The contacts server 210 may be implemented in software code written in the Ruby programming language using the Ruby on Rails framework. It will be understood, however, that the contacts server 210 may be implemented using other software languages and also in hardware or in a combination of hardware and software. The web application server host 209 may also host web server software such as the Apache web server. It will be understood, however, that the web server may be implemented using other software packages and also in hardware or in a combination of hardware and software.

The database (DB) server 211 is connected to the web application server 209 and to the improved MTA host 207. In some embodiments the database server 211 may be implemented with a cloud based Quad-Core AMD Opteron server with two gigabytes of RAM running the Linux operating system such as instances of the Amazon Elastic Compute Cloud. It will be understood, however, another suitable computer or cluster of computers may be used to implement the database server 211. It will be understood that the database server 211 may be connected to the improved MTA host 207 and the web application server 209 through the network 200, or through an independent private network.

Within the database server 211 is the contacts database (DB) 212. The contacts database 212 is used to store and access the addresses of users, correspondents, and their aliases as well as data including status of contacts and addresses contained in contacts. In some embodiments, the contact database may be implemented using a relational database such as MySQL. It will be understood that the contacts database may be implemented using other relational databases, non-relational relational databases, flat files, or other means for storing computer data.

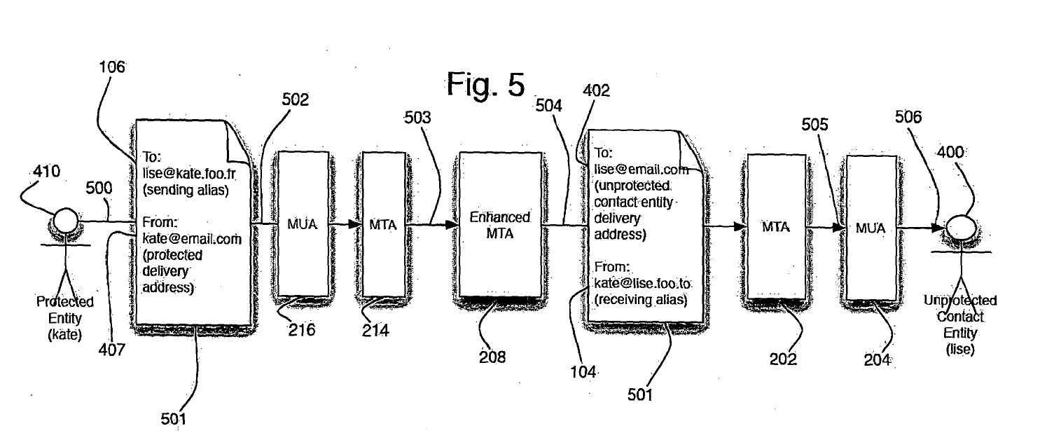

Referring now to FIG. 3 that conceptually illustrates the contacts database. The headings in each column are not actually stored as shown in the database, but are provided in FIG. 3 for illustrative purposes. The “Row#” column and actual row numbers are also not stored in the database and are provided for reference purposes only. For each combination of a protected entity delivery address 301 and a contact entity delivery address 304 the contacts database has one sending alias 302 and one receiving alias 303. Each protected entity 300 may have one or more protected entity delivery addresses 301 and associated contacts database entries. Each contact entity 305 may have one or more contact entity delivery addresses and associated contacts database entries. Each contact in the database has a status 306. This status entry reflects the state of the contact, such as ‘active’ or ‘disabled’ as shown in FIG. 3 rows one and two respectively . It will be understood that contacts may have other status entries or multiple status values as necessary to reflect characteristics of the contact in the database.

Each contact in the database has a delivery method 307. This delivery method entry reflects the state of how messages are delivered to the protected entity through this contact. The default value is “direct” which denotes that messages are to be delivered to the protected entity as they are received by the service provider. A plurality of other message delivery options are possible including daily, weekly, or monthly digest, where messages sent to the contact are queued at the service provider and sent en-masse as a single digest message at a regularly schedule time once per day, per week, or per month respectively. It will be understood that contacts may have other delivery method entries or multiple delivery method values as necessary to reflect characteristics of the contact in the database.

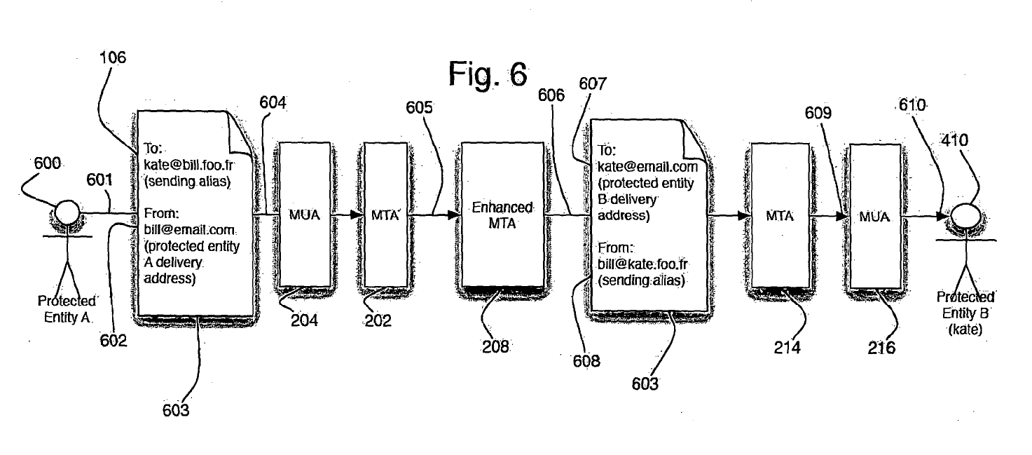

Referring now to FIG. 4 (with reference also to FIG. 1, FIG. 2, and FIG. 3) the process of sending a message from a non-system user referred to as an unprotected contact entity 400 to a system user, referred to as a protected entity 410, is described. In step 401 the unprotected contact entity 400 addresses an email 403 to the receiving alias 104 for the protected entity 410. This receiving alias 104 is represented in the database in FIG. 3 in column 303, row 1. In step 404 the email 403 is dispatched via a mail user agent 204 to a standard mail transfer agent 202 for the unprotected contact entity 400. Also in step 404 the mail user agent 204 attaches the unprotected contact entity's 400 unprotected contact entity delivery address 402 as the envelope sender and From: header address for the email message 403. This unprotected contact entity delivery address is represented in the database in FIG. 3 in column 304, row 1. In step 405 the mail transfer agent 202 delivers the email message 403 to the enhanced mail transfer agent 208. This happens because the receiving alias 104 that the email 403 is addressed to an address in a domain directed to and managed by the enhanced mail transfer agent 208. In step 406 the enhanced mail transfer agent 208 rewrites the envelope header addresses in the email message 403. The rewriting is done by looking up the contact in the database (as illustrated in FIG. 3) by the receiving alias 104 in database column 303 and the unprotected contact entity's delivery address 402 in database column 304, and retrieving the protected entity delivery address from column 301 and the sending alias from column 302 from the matching contact entry in the database. In the example shown all database values used are shown in row 1 in FIG. 3. The retrieved addresses are used in the rewriting step. In particular, the envelope recipient of the email message 403 is replaced with the protected entity delivery address 407 which is retrieved from the database lookup from column 301, row 1. Also, all instances of the unprotected contact entity delivery address 402 in the email message 403 are replaced with the sending alias 106 which is retrieved from the database lookup from column 302, row 1. Also in step 406, the modified email message 403 is delivered to the mail transfer agent 214 specified from the domain of the modified email message 403 envelope recipient address (the protected entity delivery address 407). In step 408 the email message 403 is retrieved from the mail transfer agent 214 by the mail user agent 216 of the protected entity. In step 409 the protected entity 410 can read the email from the contact entity 400.

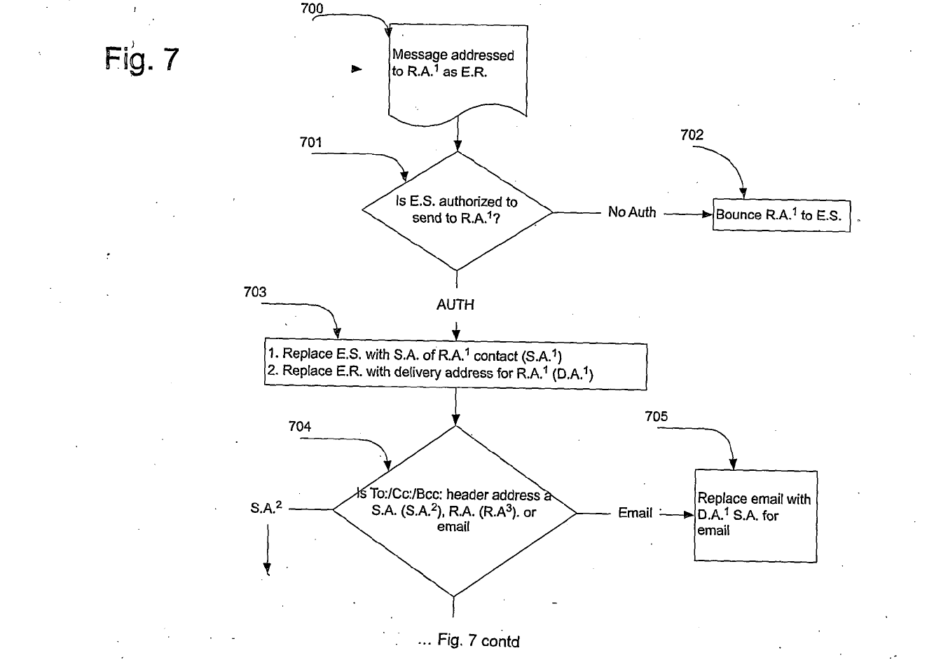

Referring now to FIG. 5 (with reference also to FIG. 1, FIG. 2, FIG. 3, and FIG. 4) the process of sending a message from a protected entity 410 to an unprotected contact entity 400 is described. In step 500 the protected entity 410 addresses an email 501 to a sending alias 106 for the unprotected contact entity 400. This sending alias 106 is represented in the database in FIG. 3 in column 302, row 1.In step 502 the email is dispatched via a mail user agent 216 to a standard mail transfer agent 214. Also in step 502 the mail user agent 216 attaches the protected entity's 410 delivery address 407 as the envelope sender and From:

header address for the email message 501. This protected entity delivery address 407 is represented in the database in FIG. 3 in column 301, row 1. In step 503 the mail transfer agent 214 delivers the email message 501 to the enhanced mail transfer agent 208. This happens because the sending alias 106 that the email is addressed to is an address in a domain directed to and managed and controlled by the enhanced mail transfer agent 208. In step 504 the enhanced mail transfer agent 208 rewrites the envelope header addresses in the email message 501. The rewriting is done by looking up the contact in the database (as illustrated in FIG. 3) by the sending alias 106 (in database column 302, row 1), and the protected entity's delivery address 407 (in database column 301, row 1), and retrieving the unprotected contact entity's delivery address from column 304, row 1, and the receiving alias from column 303, row 1 from the matching contact entry in the database (in this case row 1). The retrieved addresses are used in the rewriting step. In particular, the envelope recipient of the email message 106 is replaced with the unprotected entity's delivery address 402 which is retrieved from the database lookup from column 304, row 1. The envelope sender of the email message 106 is replaced with the receiving alias 104 which is retrieved from the database lookup from column 303, row 1. Also, all other instances of the protected entity's delivery address 407 in other fields of the email message 501 are replaced with the receiving alias 104. This helps to maintain the secrecy of the protected entity's delivery address. Also in step 504 the modified email message 501 is delivered to a mail transfer agent 202 specified from the domain of the email message 501 envelope recipient address (the unprotected contact entity delivery address 402). In step 505 the email message 501 is retrieved from the mail transfer agent 202 by a mail user agent, 204 of the unprotected contact entity. In step 506 the unprotected contact entity 400 can read the email from the protected entity 410.

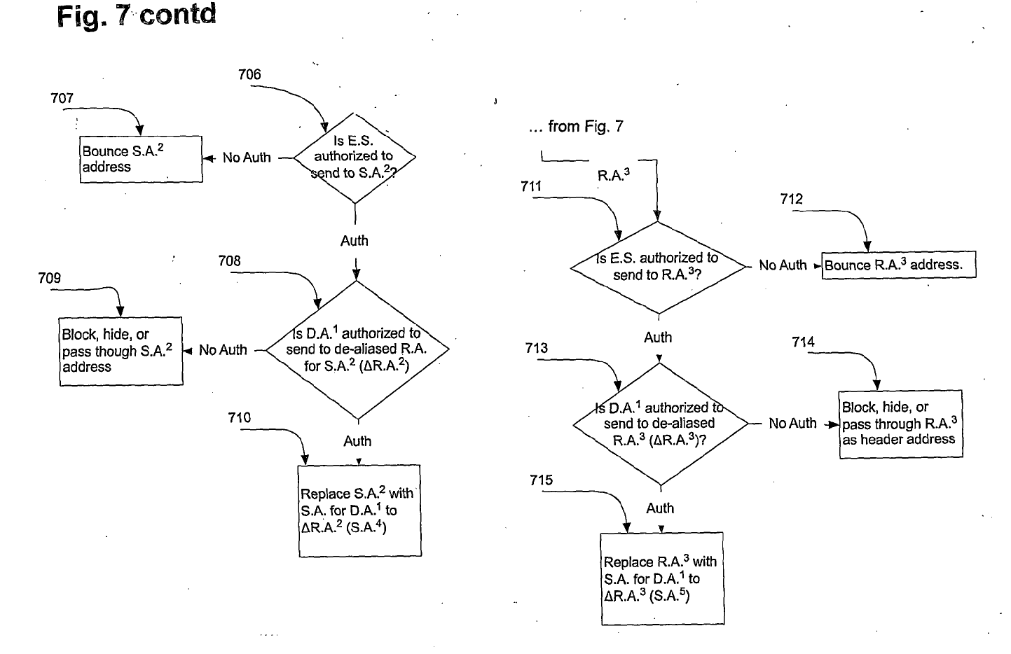

Referring now to FIG. 6 (with reference also to FIG. 1, FIG. 2, FIG. 3, and FIG. 4) the process of sending a message from a protected entity A 600 to another protected entity B 410 is described. In step 601 the protected entity A 600 addresses an email 603 to a sending alias 106 for protected entity B 410. This sending alias 106 is represented in the database in FIG. 3 in column 302, row 4. In step 604 the email is dispatched via a mail user agent 204 to a standard mail transfer agent 202 for protected entity A 600. Also in step 604 the mail user agent 204 attaches protected entity A's 600 protected entity delivery address 602 as the envelope sender for the email message 603. This protected entity delivery address 602 is represented in the database in FIG. 3 in column 301, row 4. In step 605 the mail transfer agent 202 delivers the email message 603 to the enhanced mail transfer agent 208. This happens because the sending alias 106 that the email is addressed to is an address in a domain directed to and managed by the enhanced mail transfer agent 208. In step 606 the enhanced mail transfer agent 208 rewrites the envelope header addresses in the email message 603. The rewriting is done by looking up the contact in the database (as illustrated in FIG. 3) by the sending alias 106 (in database column 302, row 4) and protected entity A's delivery address 602 (in database column 301, row 4), and retrieving the contact entity's delivery address (from column 304, row 4), and the receiving alias (from column 303, row 4), from the matching contact entry (row 4 of FIG. 3) in the database. Since protected entity A is sending this message to another protected entity, protected entity B, the contact entity delivery address which is retrieved from the previous database lookup is a receiving alias which protected entity B uses to receive messages from protected entity A. So to determine the final destination of the message, a second database lookup is made. The address retrieved from the contact entity delivery address column 304, row 4 from the previous lookup is looked up in the receiving alias column 303, row 3 and the address retrieved from the receiving alias column 303, row 4 is looked up in the contact entity delivery address column 304, row 3. The contact database entry that matches these two lookup criteria (row 3 of FIG. 3) is the contact entry of protected entity B for protected entity A as a contact entity. From this contact database entry (row 3 of FIG. 3), the protected entity delivery address is retrieved (from column 301, row 3), and the sending alias is retrieved (from column 302, row 3). The retrieved addresses are used in the rewriting step. In particular, the envelope recipient of the email message 106 is replaced with the protected entity B's delivery address 607, and the envelope sender of the email message is replaced with the sending alias 608 for protected entity B to send to protected entity A. Also, all instances of protected entity A's delivery address 602 in the email message 603 are replaced with the sending alias 608 for protected entity B to send to protected entity A. This helps to maintain the secrecy of the protected entity A's delivery address. It should be noted that the format of the sending alias of protected entity B for protected entity A 608 takes a similar form to the sending alias 106 protected entity A used to address the message to protected entity B, but that they are distinct addresses. Also in step 606 the modified email message 603 is delivered to a mail transfer agent 214 specified from the domain of the email message 603 envelope recipient address (the protected entity B's delivery address 607). In step 609 the email message 603 is retrieved from the mail transfer agent 214 by a mail user agent 216 of protected entity B 410. In step 610 protected entity B 410 can read the email from the protected entity A 600.

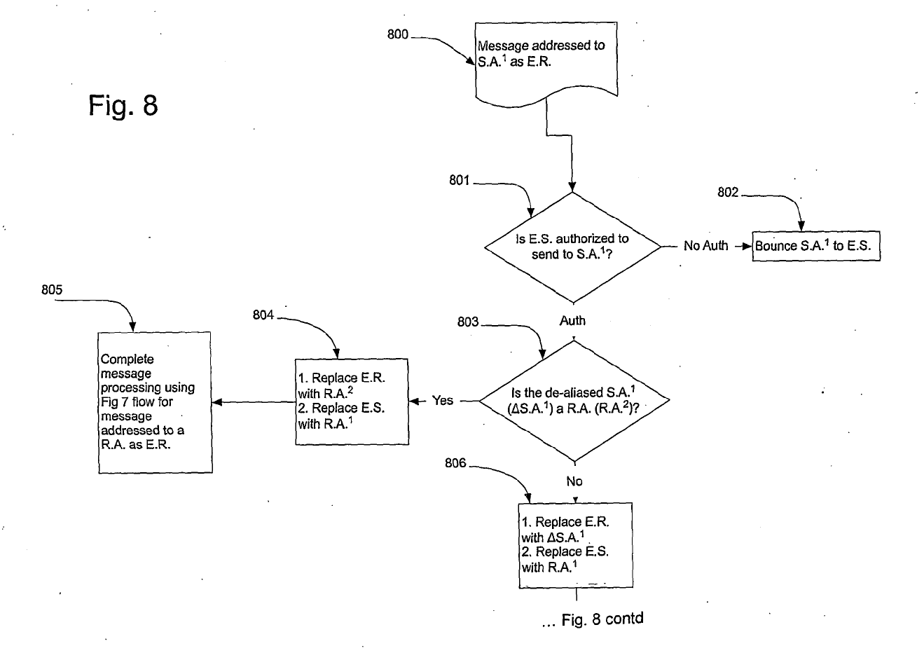

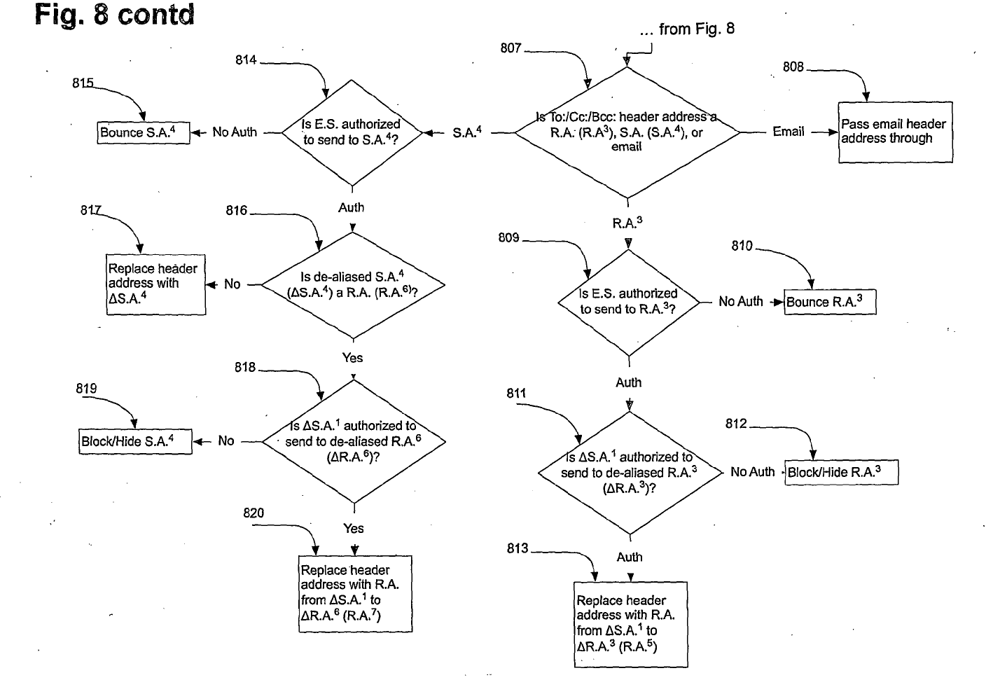

In FIG. 7 and FIG. 8 a superscript notation is used to indicate the relationship between individual values of different types of addresses and contact entries in the database. Each superscript number (e.g. 1, 2, 3, etc) is used as a suffix to an address type (sending alias, receiving alias, etc) to indicate that all address types with the same superscript suffix are part of the same contact as stored in the database. The multiple addresses displayed in a single row in FIG. 3 illustrate addresses that are part of the same contact. By extension address types with different superscript suffixes are part of different contact entries in the database.

Referring now to FIG. 7 (with reference to FIG. 2) the process of the enhanced mail transfer agent 208 processing a message addressed to a protected entity receiving alias (R.A.₁) is described. In step 700 the enhanced mail transfer agent receives a message addressed to R.A.₁ as the envelope recipient (E.R). In step 701 the record for the contact which contains R.A.₁ is looked up in the database and the envelope sender (E.S.) is checked for authorization to send to R.A.₁. If the E.S. is not authorized to send to R.A.₁, then the message is bounced, silently deleted (i.e. deleted without a notification being sent to the sender), or otherwise handled in step 702. If the E.S. is authorized to send to R.A.₁ then message processing continues in step 703.

In step 703 the envelope header addresses (the E.S. and E.R.) are rewritten. The E.S. address is replaced in all instances in the message with the sending alias for the contact which contains R.A.₁ (S.A.₁) The E.R. address (R.A.₁) is replaced with the delivery address for the contact containing R.A.₁ (D.A.₁). It should be noted if it is desirable to keep R.A.₁ confidential then it should be replaced in all instances by D.A.₁. Message processing of message header addresses continues in step 704.

In step 704 each header address which represents a potential message recipient is processed individually. In a standard email message this typically includes To:, Cc:, and Bcc: headers. Each individual header delivery address is looked up in the contact database to determine if it is a sending alias (S.A.₂), receiving alias (R.A.₃), or a standard address. If the header address is a standard address then in step 705 it is replaced in all instances in the message with the sending alias for this standard address belonging to the owner of D.A.₁ (the protected entity addressed by the message E.R.). If no such sending alias previously exists in the database (this is the first protected communication from D.A.₁ to the standard address), then a new sending alias and associated contact is created for the standard address.

If in step 704 the header address is found to be S.A.₂ then processing of S.A.₂ continues in step 706. In step 706 the authorization of the E.S. to send to S.A.₂ is checked. If the E.S. is not authorized to send to S.A.₂, then in step 707 S.A.₂ is removed from the message or otherwise handled, and a bounce message may be sent to the E.S. to indicate that the message was not delivered to S.A.₂. If the E.S. is authorized to send to S.A.₂ then processing of S.A.₂ continues in step 708.

In step 708 the authorization of D.A.₁ to send to the de-aliased receiving alias for S.A.₂ (ΔR.A.₂) is checked. If D.A.₁ is not authorized to send to ΔR.A.₂ then in step 709 S.A.₂ is hidden or otherwise handled in the message. (This prevents D.A.₁ from sending messages to ΔR.A.₂ since D.A.₁ is not authorized to do so. In some cases S.A.₂ may be passed through in the message if the owner of S.A.₂ does not wish to keep the address confidential and/or it is important that D.A.₁ is aware that the message has been sent to S.A.₂. Alternately, S.A.₂ may be completely hidden or an undisclosed address header or similar indicator may take the place of S.A.₂ in the message.) If D.A.₁ is authorized to send to ΔR.A.₂, then in step 710 S.A.₂ is replaced in all instances in the message with a sending alias for D.A.₁ to send to ΔR.A.₂ (S.A.₄). If no such sending alias previously exists in the database, such as the case where this is the first protected communication from D.A.₁ to ΔR.A.₂, then a new sending alias and associated contact can be created.

Returning to step 704, if the header address is determined to be a receiving alias (R.A.₃) then processing of the header address continues in step 711.

In step 711 the authorization of the E.S. to send to R.A.₃ is checked. If the E.S. is not authorized to send to R.A.₃ then in step 712 R.A.₃ is removed from the message or otherwise handled and a bounce message is sent to the envelope sender to indicate that the message was not delivered to R.A.₃. If the envelope sender is authorized to send to R.A.₃ then header processing continues in step 713.

In step 713 the authorization of D.A.₁ to send to the de-aliased address for R.A.₃ (ΔR.A.₃) is checked. If D.A.₁ is not authorized to send to ΔR.A.₃ then in step 714 R.A.₃ is hidden or otherwise handled in the message. (This prevents D.A.₁ from sending messages to ΔR.A.₃ since D.A.₁ is not authorized to do so. In some cases R.A.₃ may be passed through in the message if the owner of R.A.₃ does not wish to keep the address confidential and/or it is important that D.A.₁ is aware that the message has been sent to R.A.₃. Alternately, R.A.₃ may be completely hidden or an undisclosed address header or similar indicator may take the place of R.A.₃ in the message.). If D.A.₁ is authorized to send to ΔR.A.₃ then header processing continues in step 715.

In step 715 R.A.₃ is replaced with a sending alias for D.A.₁ to send to ΔR.A.₃ (S.A.₅). (If no such sending alias previously exists in the database, such as the case where this is the first protected communication from D.A.₁ to ΔR.A.₃, then a new sending alias and associated contact can be created.)

Once all the address headers are processed the message is delivered to the envelope recipient.

Referring now to FIG. 8 (with reference to FIG. 2 and FIG. 7) the process of the enhanced mail transfer agent 208 processing a message addressed to a protected entity sending alias is described. In step 800 the enhanced mail transfer agent receives a message addressed to a sending alias (S.A.₁) as the envelope recipient (E.R.). In step 801 the contact which contains S.A.₁ is looked up in the database and the envelope sender (E.S.) is checked for authorization to send to S.A.₁. If the E.S. is not authorized to send to S.A.₁, then the message is bounced or otherwise handled in step 802. If the E.S. is authorized to send to S.A.₁ then message processing continues in step 803.

In step 803 the de-aliased S.A.₁ (ΔS.A.₁) is checked to determine if it is a receiving alias (R.A.₂). If ΔS.A.₁ is R.A.₂ then message processing continues in step 804.

In step 804 the E.R. address is replaced with R.A.₂ and the E.S. address is replaced with the receiving alias of the contact containing S.A.₁ (R.A.₁). The message is now addressed to a receiving alias, and in step 805 message processing is completed using the logic described in FIG. 7.

Returning to step 803, if ΔS.A.₁ is not R.A.₂ message processing continues in step 806. In step 806 the E.R. is replaced with ΔS.A.₁ and the E.S. is replaced with R.A.₁. Message processing continues in step 807.

In step 807 each header address which represents a potential message recipient is processed individually. In a standard email message this typically includes the To:, Cc:, and Bcc: headers. Each individual header delivery address is looked up in the contact database to determine if it is a receiving alias (R.A.₃), sending alias (S.A.₄), or a standard address. If the header address is a standard address, then the address is passed through “as is” in the message in step 808. Returning to step 807, if the header address is found to be R.A.₃ then message processing continues in step 809.

In step 809 R.A.₃ is looked up in the database and the authorization of the E.S. to send to R.A.₃ is checked. If the E.S. is not authorized to send to R.A.₃ then a bounce message is returned to the E.S. indicating that the message was not delivered to R.A.₃ or the message can be otherwise handled in step 810.

Returning to step 809 if the E.S. is authorized to send to R.A.₃ then processing continues in step 811.

In step 811 the database is checked to determine if the de-aliased E.R. (ΔS.A.₁) is authorized to send to the de-aliased R.A.₃ (ΔR.A.₃). If ΔS.A.₁ is not authorized to send to ΔR.A.₃ then the header address R.A.₃ is blocked, hidden, or otherwise handled in step 812.

Returning to step 811. If ΔS.A.₁ is authorized to send to ΔR.A.₃ then in step 813 the header address R.A.₃ is replaced in all instances in the message with a receiving alias for ΔS.A.₁ to send to ΔR.A.₃ (R.A.₅). (If no such sending alias previously exists in the database, such as the case where this is the first protected communication from ΔS.A.₁ to ΔR.A.₃, then a new sending alias and associated contact can be created.)

Returning to step 807 if the header address is a sending alias S.A.₄, then processing continues in step 814. In step 814 the database is checked to determine if the envelope sender is authorized to send to S.A.₄. If the envelope sender is not authorized to send to S.A.₄ then a bounce message is returned to the envelope sender indicating that the message was not delivered to S.A.₄ or the message may be otherwise handled in step 815.

Returning to step 814 if the envelope sender is authorized to send to S.A.₄ then processing continues in step 816. In step 816 S.A.₄ is looked up in the database to determine if the de-aliased address S.A.₄ (ΔS.A.₄) is a receiving alias R.A.₆. If ΔS.A.₄ is not a receiving alias, the header address S.A.₄ is replaced in the message with ΔS.A.₄ in step 817.

Returning to step 816 if ΔS.A.₄ is R.A.₆ then processing continues in step 818. In step 818 the database is checked to determine if ΔS.A.₁ is authorized to send to the de-aliased address of R.A.₆ (ΔR.A.₆). If ΔS.A.₁ is not authorized to send to ΔR.A.₆ then S.A.₄ is blocked, hidden, or otherwise handled in step 819.

Returning to step 818 if ΔS.A.₁ is authorized to send to ΔR.A.₆ then S.A.₄ is replaced in the message with a receiving alias for ΔS.A.₁ to send to ΔR.A.₆ (R.A.₇) in step 820. (If no such receiving alias previously exists in the database, such as the case where this is the first protected communication from ΔS.A.₁ to ΔR.A.₆, then a new receiving alias and associated contact can be created.)

It will be appreciated that step 804 does not necessarily require replacement of the email addresses in the envelope sender and envelope recipient fields, although this allows the process of FIG. 7 to be executed in a straightforward manner. Alternatively, the email message could be processed differently although providing the same result. This may involve for instance step 804 generating a record of a notional envelope recipient and a notional envelope sender and FIG. 7 processing the email message for the notional envelope sender and recipients generated in step 804.

Once all header addressed have been processed the message is delivered.

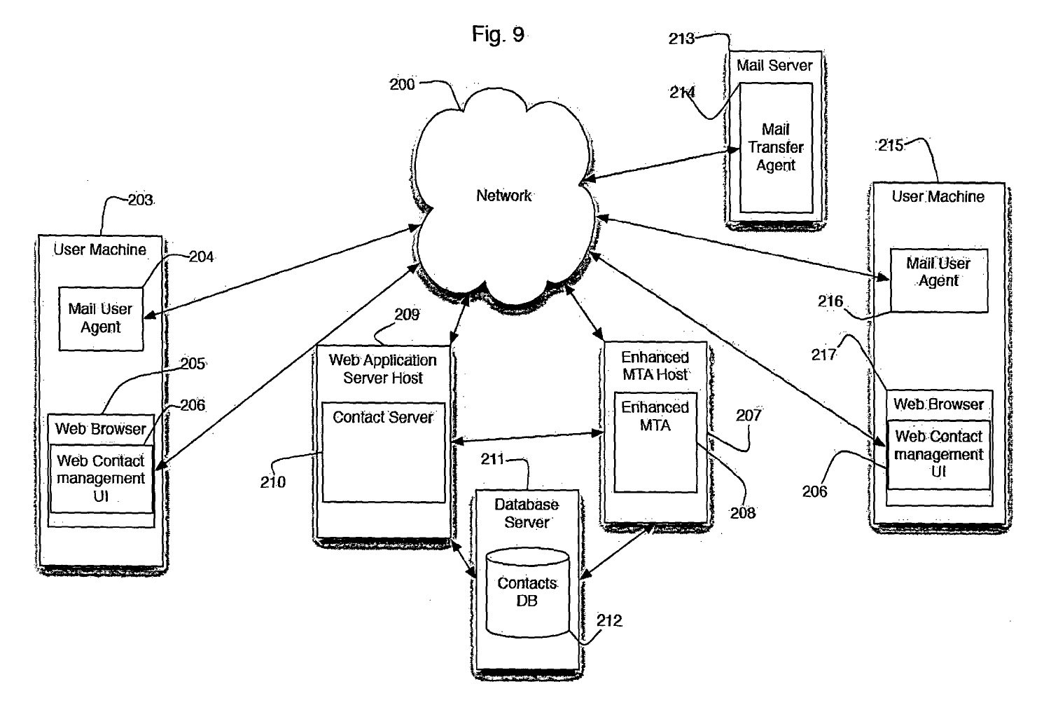

Referring now to FIG. 9 an alternative system configuration where the enhanced MTA services are provided by the primary email service provider is described. The services provided by the enhanced MTA 208 may be delivered directly to an end user by their primary email provider. In this case, functions of the mail server 201 and mail transfer agent 202 in message delivery are handled directly by the enhanced MTA host 207 and the enhanced MTA 208. In this configuration, all mail sent from the user's machine 203 is delivered through the network 200 to the enhanced MTA 208, and all mail sent to the user's mail user agent 204 from the enhanced MTA 208 is delivered through the network 200 to the user's machine 203. When the enhanced MTA 208 is hosted in the primary email service provider's environment, the need for an intermediate mail server 201 and mail transfer agent 202 is removed. Users can send and receive messages through their mail user agent 204 directly to and from the enhanced MTA 208. In this configuration, all messages to and from the user can be routed through the enhanced MTA 208.

Users can manage their accounts, for instance managing their primary email address and sending and receiving aliases for contacts, in any suitable way. Some examples will now be described.

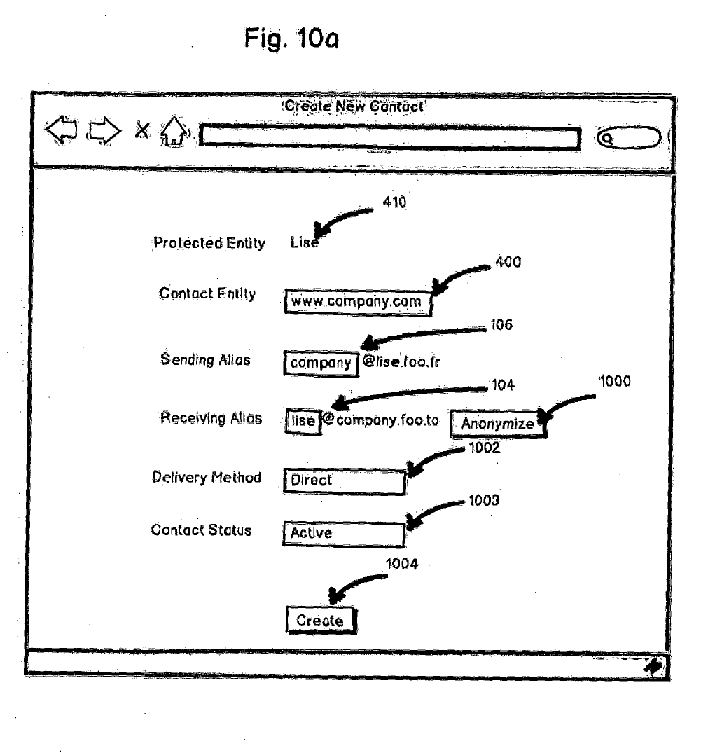

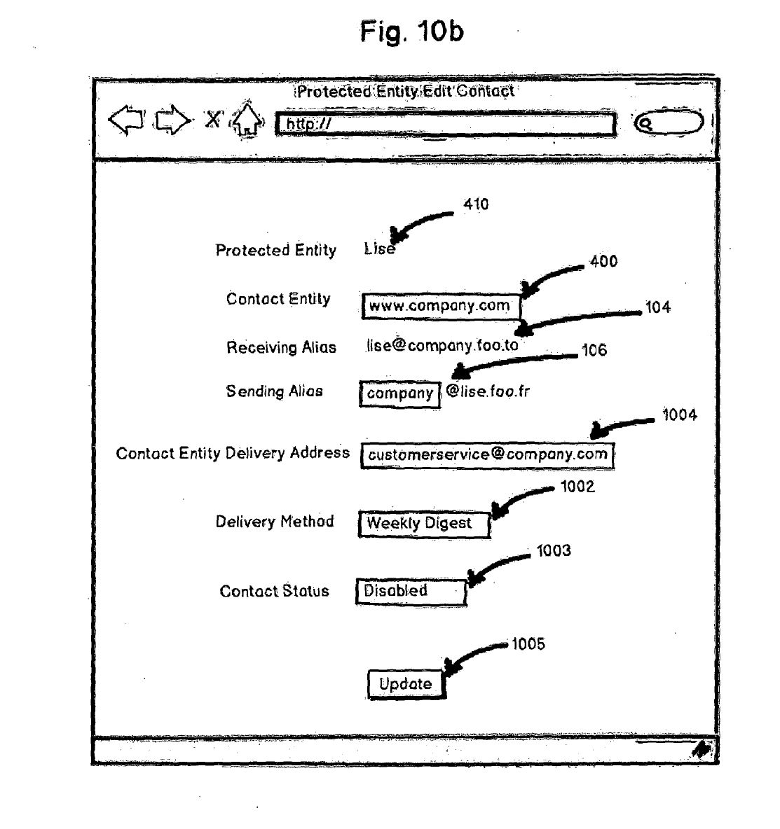

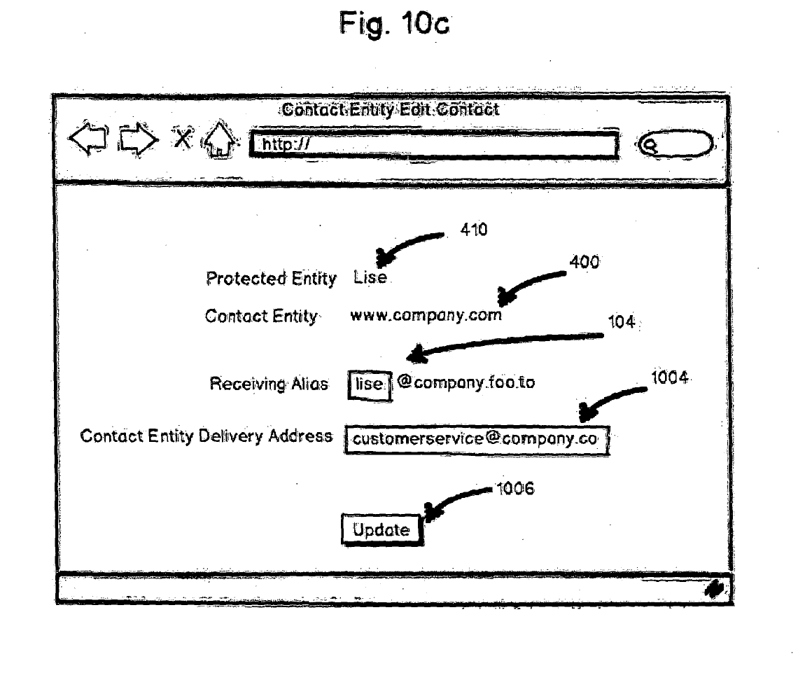

Referring now to FIG. 10a the process of operating a web contact management user interface (UI) 206 to create a new connection and related functionality is described. FIG. 10a illustrates a component of the UI for setting the attributes of a new connection. The core attributes shown in the UI are the protected entity name 410, the contact entity name 400, the sending alias 106, the receiving alias 104, the contact delivery method 1002, and the contact status 1003. In some embodiments of the invention, all attributes of the contact are set automatically based on the protected entity name, contact entity name, and default values. In alternate embodiments of the invention, all of these attributes except the protected entity name 410 may be modified through the UI by the protected entity at the time of contact creation. Specific modifications to individual contact attributes provide enhanced system functionality, described below.

The protected entity can explicitly set the contact entity name 400. Allowing the user to set the contact entity name can help to ensure that it is memorable and/or identifiable by the user. The contact entity name 400 can also be set automatically by an implicit or explicit user action such as clicking a button on a web page to connect to a website or a plurality of other actions.

The protected entity can explicitly set the username portion of the sending alias 106. Setting the username portion of the sending alias 106 for a contact to an easy to remember name is an important convenience for the protected entity. Since all of the protected entity's 410 addresses use the same sending alias domain and sub-domain (lise.foo.fr in this example) the protected entity only needs to remember the unique username of any contact in order to send them an email using their protected entity delivery address. This method of messaging works from any device, and reduces or eliminates the need to synchronize contact lists across devices.

The protected entity may explicitly set the username portion of the receiving alias 104. In an alternative embodiment of the invention, the receiving alias for a new contact may not be known to the protected entity, and in this case could not be explicitly set. In this case the receiving alias is privileged information for contact entity. Keeping the receiving alias confidential and known only to the contact entity, helps to maintain the secrecy of the receiving alias.

The protected entity may use the anonymise button 1000 to change the receiving alias 104 to a unique anonymous address, which has no relation to their username or identity, such as a randomized address e.g. 143random@563random.foo.to. The use of an anonymous receiving alias can be useful to prevent tracking of the protected entity based on email address, or correlation to other compiled information based on email address. An anonymous receiving alias can also be useful when an address needs to be given to an untrusted party or when the protected entity wishes to remain anonymous in the dealings and communications with the contact entity.

The protected entity may explicitly set the delivery method 1002 to customize how messages are delivered for the specific connection. For example a protected entity, acting as a customer of a retail store, may create a contact with that store to receive marketing and promotional email. If the protected entity wishes to receive only one email from this contact per week, then they can set the delivery method to weekly digest, which causes all messages for a given week to be buffered, concatenated and delivered as a single digest message once per week. This can be a useful feature for the protected entity and for the retail contact entity to easily allow customers to set their own preferences for mail delivery without material changes to scheduling or sending of messages by the retailer. A plurality of delivery methods are possible within the design of the system.

The protected entity may explicitly set the contact status 1003 to alter or customize how the contact handles messages. In the example shown the field is set to a default value of “Active”. A plurality of other contact statuses can be defined and implemented to match preferred contact behaviour. These can include bouncing all messages, silently deleting all messages, or restricting the set of authorized senders, and a plurality of other desired behaviours. A plurality of delivery methods are possible within the design of the system.

The create button 1004 instantiates the contact and persists it in the contact database 212.

It is understood that other mechanisms can be used to modify the contact attributes and instantiate and persist a contact in the contact database including integrations to other systems without the use of a UI such as through a web services API.

Referring now to FIG. 10b (also with reference to FIG. 10a) the process of a protected entity operating a UI to edit an existing contact and related functionality is described. FIG. 10b illustrates a component of the UI for updating the attributes of an existing connection. The core attributes shown in the UI are the protected entity name 410, the contact entity name 400, the receiving alias 104, the sending alias 106, the contact entity delivery address 1004, the contact delivery method 1002, and the contact status 1003. The contact entity name 400, the sending alias 106 username, the contact delivery method 1002, and the contact status 1003 can be modified in this UI with the same results and functionality as described in FIG. 10a.

The protected entity can modify the contact entity delivery address 1004 through this UI. The effect of modifying this field is to either re-assign the contact to a new recipient, or to update the delivery address for the contact in the case where the contact has changed their message delivery address. In either case, the protected entity can continue to use the same sending alias 106 to send messages to the contact, even after that contact's address has changed. The benefit here is if the protected entity has saved the sending alias for the contact in a messaging tool or device such as an email client or mobile phone, they do not have to update those individual tools or devices when the contact's email address changes or if the contact is reassigned to a new entity. The protected entity may change the contact entity delivery address 1004 and continue to use the same sending alias to deliver messages to the contact from any and all devices.

The update button 1005 persists the changes in the contact database 212.

It is understood that other mechanisms can be used to modify the contact attributes and persist a contact in the contact database including integrations to other systems without the use of a UI such as through a web services API.

Referring now to FIG. 10c the process of a contact entity operating a UI to edit an existing connection and related functionality is described. FIG. 10c illustrates a component of the UI for updating the attributes of an existing connection by the contact entity. The core attributes shown in the UI are the protected entity name 410, the contact entity name 400, the receiving alias 104, and the contact entity delivery address 1004.

The contact entity may modify the receiving alias 104 username through this UI. The effect of changing the receiving alias 104 username is to create a new receiving alias through which the contact entity and any other authorized entities can send messages to the protected entity. Depending on the conditions of the specific situation, the former receiving alias can continue to function, function in a limited fashion (such as only accepting messages from previously known senders), or be disabled completely. This feature may be useful to perform disaster recovery in the event where a contact entity such as a web based business loses their customer's email address (in this case a receiving alias for their customer) or has this addresses stolen by a computer cracker or criminal entity. When such a loss or theft occurs the web based business (the contact entity) can change (or request to have changed) the receiving aliases they hold for their compromised customer contacts, and to disable or limit the former receiving aliases. This has the effect of rendering the lost or stolen addresses (receiving aliases) useless, and the new receiving aliases re-establish a private message pathway to the customers, all with minimal or no visible change to the customers (protected entities). (The degree of change visible depends on if the receiving alias used to send a message is disclosed to the protected entity. It is understood that there are embodiments of the present invention both where the receiving alias is disclosed and is not disclosed to the protected entity.)

The contact entity may modify the contact entity delivery address 1004 though the UI. The effect of this is to allow the contact entity to change the address where they can receive messages from the protected entity. It is understood that in some embodiments of the present invention that the ability for a contact entity to change the contact entity delivery address 1004 can be verified through sending a validation email to the proposed new address, or through other means of email address validation.

The update button 1006 is shown in the UI to illustrate a method by which the contact entity can commit their updates to the contact to the contact database. It is understood that other mechanisms can be used to update the contact database including integrations to other systems without the use of a UI such as through a web services API.

With the UIs shown in FIGS. 10a to 10c, it will be appreciated that settings applied by a user are stored in a database record, such as one of the records shown in FIG. 3, so as subsequently to allow the desired handling of emails by the enhanced MTA 208.

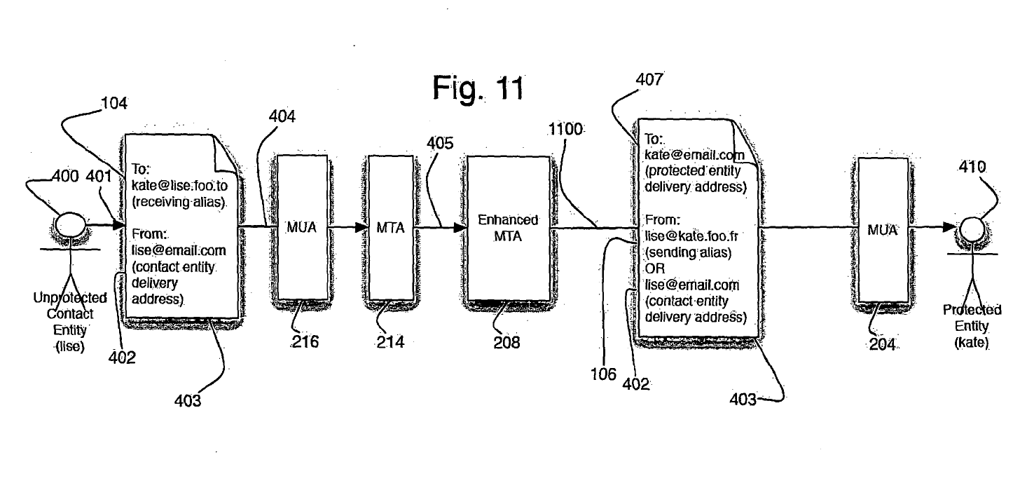

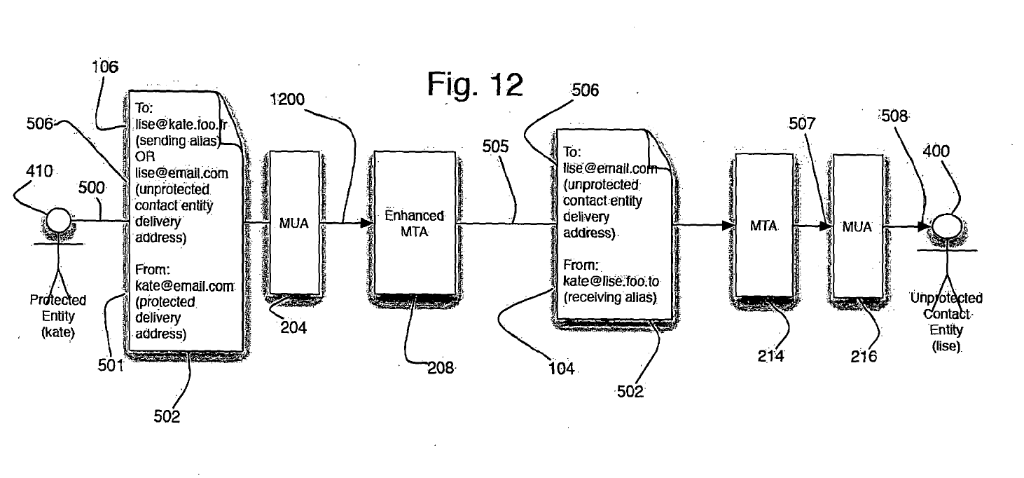

Referring now to FIG. 11 (with reference to FIG. 1, FIG. 2, FIG. 3, and FIG. 4) an alternative process of sending a message from a non-system user referred to as an unprotected contact entity 400 to a system user, referred to as a protected entity 410, is described. The process described here is the same use case as described in FIG. 4, but in this case the enhanced MTA 208 is hosted by the primary email service provider for the protected entity 410. The process is similar to the process described in FIG. 4, except for the following differences. In step 1100 the enhanced mail transfer agent 208 rewrites the envelope header addresses in the email message 403. The rewriting is done by looking up the contact in the database (as illustrated in FIG. 3) by the receiving alias 104 in database column 303, row 1 and by the unprotected contact entity delivery address from column 304, row 1. The protected contact entity's delivery address 407 is retrieved from the matching contact record in the database (row 1) from database column 301, row 1, and the sending alias is retrieved from column 302, row 1 from the matching contact entry in the database. The retrieved addresses are used in the rewriting step. The envelope recipient of the email message 403 is replaced with the protected entity delivery address 407 which is retrieved from the database lookup from column 301, row 1. The envelope sender of the email message 403 is replaced with the sending alias 106. All instances of the unprotected contact entity delivery address 402 in the email message 403 may be replaced with the sending alias 106 which is retrieved from the database lookup from column 302, row 1. However, the service provider hosting the enhanced MTA 208 may choose not to use sending aliases for some or all messages, and instead can skip the replacement of the unprotected contact entity delivery address 402 in the envelope sender field and all other instances and instead pass through the unprotected contact entity delivery address 402 as in the original message. The protected entity delivery address 407 can still be kept secret by the primary email services provider with the embedded enhanced MTA. This is described in more detail in FIG. 12.

Referring now to FIG. 12 (with reference also to FIG. 1, FIG. 2, FIG. 3, and FIG. 5) an alternative process of sending a message from a protected entity 410 to an unprotected contact entity 400 is described. The process described here is the same use case as described in FIG. 5, but in this case the enhanced MTA 208 is hosted by the primary email service provider for the protected entity 410. The process is similar to the process described in FIG. 5, except for the following differences. In step 1200 the email is dispatched via a mail user agent 204 directly to the enhanced MTA 208. Also in step 1200 the mail user agent 204 attaches the protected entity's 410 delivery address 501 as the envelope sender and From: header address for the email message 502. Another important difference is that the protected entity 410 can opt to use the unprotected contact entity delivery address 506 as the original recipient of the message and does not need to use a sending alias. If the protected entity 410 addresses the message to the unprotected contact entity delivery address 506 then the address rewriting in step 505 is changed as follows. In step 505 the enhanced mail transfer agent 208 rewrites the envelope header addresses in the email message 502. The rewriting is done by looking up the contact in the database (as illustrated in FIG 3) by the contact entity delivery address 506 in database column 304, row 1 and the protected entity's delivery address 501 in database column 301, row 1. The receiving alias 104 is retrieved from column 303, row 1 from the matching contact entry in the database(row 1). The retrieved address is used in the rewriting step. The envelope sender and From: header of the email message 502 is replaced with the receiving alias 104. All instances of the protected entity delivery address 501 in the email message 502 may be replaced with the receiving alias 104 to maintain the secrecy of the protected entity delivery address.

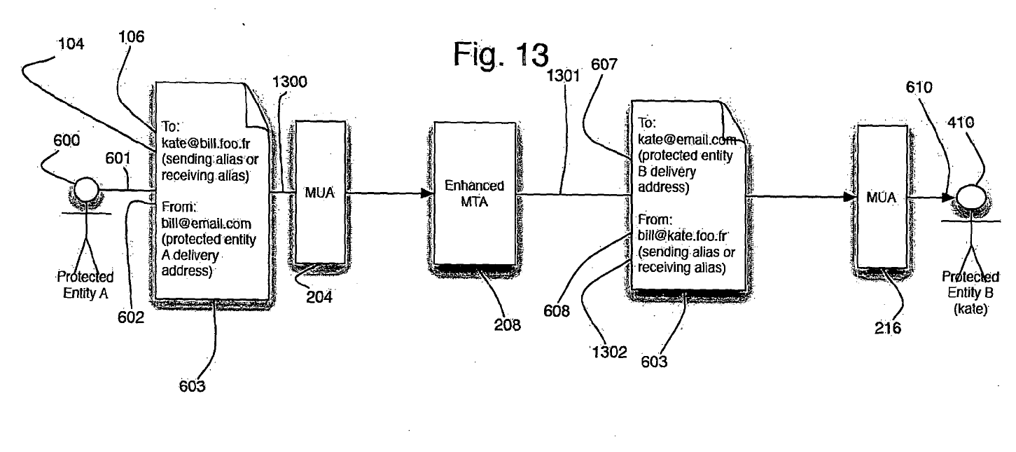

Referring now to FIG. 13 (with reference also to FIG. 1, FIG. 2, FIG. 3, and FIG. 6) an alternative process of sending a message from a protected entity A 600 to an protected entity B 410 is described. The process described here is the same use case as described in FIG. 6, but in this case the enhanced MTA 208 is hosted by the primary email service provider of both protected entities A 600 and B 410. The process is similar to the process described in FIG. 6, except for the following differences. In all cases in step 1300 the email message 603 is delivered via the mail user agent 204 directly to the enhanced mail transfer agent 208. In all cases in step 1301 the modified email message 603 is delivered to the mail user agent 216 directly from the enhanced mail transfer agent 208. In step 601 the protected entity A 600 may address the email 603 to a sending alias 106 for protected entity B 410 or directly to the receiving alias 104 for protected entity B 410. These addresses may be syntactically identical but are stored differently in the system database and perform distinct roles in the system based on this context. If a receiving alias 104 is used to address the message in step 601, then the database lookup performed in step 1301 differs from the lookup in step 606 as follows. In step 1301 the enhanced mail transfer agent 208 rewrites the envelope header addresses in the email message 603. The rewriting is done by looking up the contact in the database (as illustrated in FIG. 3) by the receiving alias 104, which in this context acts as a contact entity delivery address, and is looked up in database column 304, row 4 and protected entity A's delivery address 602 in database column 301, row 4, and retrieving the receiving alias from column 303, row 4 from the matching contact entry in the database. Since protected entity A is sending this message to another protected entity, protected entity B, a second database lookup is needed. The receiving alias 104 is looked up in the column 303, row 3 and the address retrieved from the receiving alias column 303, row 4 is now looked up in the contact entity delivery address column 304, row 3. The contact database entry that matches these two lookup criteria is the contact entry of protected entity B for protected entity A as a contact entity (row 3). From this contact database entry we retrieve the protected entity delivery address from column 301, row 3, which is the protected entity delivery address for protected entity B 410. The retrieved address is used in the rewriting step. The envelope recipient of the email message 104 is replaced with the protected entity B's delivery address 607. Protected entity A's delivery address can be replaced in the envelope sender and From: headers with the contact entity delivery address 1302 (from column 304, row 4). Alternately, the sending alias from column 302, row 3 may be used to replace protected entity A's delivery address, as is done in FIG. 6. In addition, all instances of protected entity A's delivery address 602 in the email message 403 may be replaced with either the receiving alias 1302 or sending alias 608 for protected entity B to send to protected entity A depending on which method is used. In either case for clarity one address should be used for all replacements. Because the enhanced MTA 208 is hosted at the primary email service provider, the service provider can still maintain the secrecy of the delivery addresses for both protected entities A and B.

### Simple User Experience

From the system user's perspective, some embodiments of the present invention utilize alias identities in the form of paired sending aliases and receiving aliases to allow correspondents to privately send and receive email. Receiving aliases allow users of the system to receive messages from correspondents without revealing their primary email delivery address. Sending aliases are paired to receiving aliases and allow users to send email to correspondents without disclosing their primary email delivery addresses. Sending and receiving aliases are part of a user-controlled communications “contact” which also includes delivery addresses for the user and the correspondent.

In some embodiments of the present invention, users of the invention have a unique communication “contact” with every individual, organization, and entity with which they wish to communicate privately. This effectively establishes one unique communication identity for the system user with each party with whom they communicate.

The use of some embodiments of the system by an end user is intentionally simple. Most of the technical complexity is handled by computing systems. The user experience is similar to the use of current communication systems such as email, but with some key differences.

The first key difference is that a typical email user conventionally has one email address such as lee@email.com that they give to every entity from whom they wish to receive messages. With the present invention a user of the system gives a unique address to each entity from whom they wish to receive messages, such as lee@entity1.email.com, lee@entity2.email.com, etc. In the description above these addresses are referred to as receiving aliases. If authorization and security measures are taken to ensure that only the recipients of these unique addresses, or their authorized agents, can use these addresses to deliver messages, then the system user can accurately monitor and control the root source of all received messages.

The second key difference is that a typical email user uses the same address to email their friend Joe—joe@email.com—that everyone else uses. In the present invention a user of the system has a unique address that they use to email Joe—joe@lee.email.com. In the description above these addresses are referred to as sending aliases.

When a system user addresses and sends a message to a sending alias such as joe@lee.email.com, the user's primary email delivery address is not revealed, and instead the From: address on the message as delivered is the receiving alias for that contact, such as lee@joe.email.com. Similarly when Joe sends Lee a message through his sending alias lee@joe.email.com, when the message is received by Lee, it appears as sent from joe@lee.email.com, which is Lee's sending alias for Joe. So in either case, to reply to these messages, there is no change in behaviour; the message recipient simply replies to the message and the addressing, delivery, and privacy protection is all handled automatically by the system.

In some embodiments of the invention, both sending alias and receiving alias addresses take the same simple form—recipient@sender.domain, or more simply expressed to@from.domain. So for sending a message, the address looks like you@me.domain, where ‘you’ is the name of the recipient, ‘me’ is the name of the sender, and ‘domain’ is a domain. If receiving a message the address looks like me@you.domain.

This relatively simple but fundamental change to message addressing and the more complex systems that ensure delivery provide a number of additional significant benefits as described in more detail below.

### Revoke Email Address Sharing

The system allows the user to deactivate any individual contact, effectively revoking permission for email from correspondents of the contact to be delivered. This is useful when an individual no longer wants to correspond with a specific third party. For an individual user it can effectively act as a universal unsubscribe, so there is no doubt when the individual wants to stop receiving communications. In addition, the user experience is the same simple interface for unsubscribing to any and all contacts. This feature is also simple and useful for when connected third parties suffer from security breaches or digital attacks. If a company loses a customer's email address, if the customer is a user of the system they can simply turn off the connection. Then the individual can create a new connection and change their contact details with the company, or alternatively create a new registration.

### Connection Specific Delivery Modification

The user may also modify the terms of delivery through an individual contact, e.g. setting a convenient delivery time and/or location for messages or combining the delivery of multiple messages into single digest style message to reduce and organize email delivery. For example if a user subscribes to multiple daily discount/deal emails, they may choose to have the system queue these messages, concatenate them and deliver a single daily deal digest message tailored to the individual user. These delivery modifications can impact a single contact, or apply across multiple related contacts.

### Lifetime Mental Address Book

The system according to the invention allows users to maintain lifetime sending aliases for correspondents. Sending aliases allow users to address email to an easy to remember custom address, which re-routes the message to the current delivery address for the correspondent. If in future the correspondent changes their primary email delivery address, users only need to update this information in the “contact” for the sending alias for that correspondent, and can continue to use the lifetime sending alias to address email to the correspondent at the new delivery address. These sending aliases can be used from any and all devices that send email.

Freedom to Change your Email Address

The system according to the invention allows users to change their primary email delivery address and still receive email from correspondents through receiving aliases without informing their correspondents of the delivery email address change. The user simply updates their email delivery address in one or more contacts and email addressed to the receiving alias for those contacts is rerouted to the new delivery address.

### Email Identity Security System

The system allows an added layer of security for any organization or business to protect, monitor and recover from customer email data theft or loss. In the system described, when a customer creates a contact with an organization or business through the service, the customer's primary (delivery) address is not shared with the business directly. The service provider can be the only custodian of the individual customer's (protected entity's) delivery address. In some implementations of the system, the service provider would use strong encryption and other best available security practices to protect the customer's private email address. When the individual makes the contact to the organization, the organization is given either a receiving alias (if they are not using the service) or a sending alias (if they are using the service). In either case, the organization does not receive the individual's private email address, and therefore cannot lose it or have it stolen. This is especially important in today's business environment where many firms use third parties to send and process email to their customers. When businesses give these third parties access to their customer's email addresses, this data then becomes vulnerable to any loss or breach in the third party's systems. Any loss of an individual's private email address can cause long term damage to the individual through SPAM, exposure to email fraud such as phishing attacks, or even contribute to potential identity theft. For the businesses in many countries loss of customer private data requires a public disclosure to all potentially effected customers, and even fines. However when a business is holding sending aliases or receiving aliases created by the service, this data may not be classed as individual private data, and can shield the company from liability in the case of loss or theft.

### Customer Identity Security Monitoring

In addition to liability protection of loss of customer email contact details, the system also provides active monitoring of the use of receiving aliases and sending aliases, which can detect potential abuse and alert business owners and/or individuals in the case of potential abuse. Since each contact is a private communication connection between two parties, various methods can be used to establish and authenticate the identity of senders on an individual private connection. This can be done simply by registering which authorized email addresses can send to a specific connection, or can utilize more authoritative techniques such as SPF authentication, private/public key signing of messages by senders, and registration of authorized message delivery IP addresses. Whichever methods are used to establish authorized senders, the system can monitor all messages sent to a connection, and alert one or more connected parties if an unauthorized sender attempts to send a message through the private channel. Through this technique businesses can actively monitor their private communication connections to their customers and are alerted at any attempt of unauthorized communication to their customers.

### Seamless Customer Data Disaster Recovery

If an unauthorized communication is detected, or a loss or breach of customer email addresses is suspected, business users of the system can seamlessly recover their private secure communication connection with little or no impact to the customer. In the case where a business is a user of the system, their customer email addresses are stored in their internal systems (and those of their authorized partners) as sending aliases. If one or more of these sending aliases is lost or stolen, the system can simply disable the compromised sending alias, and generate a new private sending alias. Messages delivered to the new sending alias are identical from the customer perspective as messages sent to the compromised address, so the customer will be completely unaffected. When the compromised address is disabled, this can be done silently—where all messages to the address are either logged or simply deleted. The logs can be used for security forensics or investigation. But in either case, if an unauthorized third party has gained access to these sending aliases, they will not know that they have been disabled. It is important to note that organizational users of the system can create private connections through the use of sending aliases to all of their individual customers regardless of whether or not the individuals are users of the service.

In the case where the business is not a user of the system, their internal databases (and those of their partners) will hold receiving aliases for all individual users of the system. In the case of data loss or breach, receiving aliases can also be seamlessly updated if the business can update their records and the individual system user authorizes the change.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope of the invention as defined by the claims.

1. A method comprising:
receiving an email message at a service provider, the email message having in an envelope sender field a sender's email address relating to an unprotected sending contact entity and in an envelope recipient field a receiving alias email address relating to a protected receiving contact entity;
wherein the receiving alias email address includes a domain that is controlled by the service provider such that the email message is addressed to the protected receiving contact entity via the service provider,
identifying a database record containing the receiving alias email address;
extracting from the database record a protected entity delivery email address for the protected receiving contact entity;
substituting the receiving alias email address in the envelope recipient field of the email message with the protected entity delivery email address; and
determining a sending alias email address for the unprotected sending contact entity, the sending alias email address identifying a domain that is controlled by the service provider;
substituting the sender's email address in the envelope sender field of the email message with the sending alias email address; and
sending the email message with the substituted envelope sender and envelope recipient email addresses.

2. (canceled)

3. A method as claimed in claim 1, wherein determining a sending alias email address for the unprotected sending contact entity comprises:
identifying a database record containing both the recipient's email address and the sender's email address; and
extracting from the database record the sending alias email address for the unprotected sending contact entity.

4. A method as claimed in claim 1, wherein determining a sending alias email address for the unprotected sending contact entity comprises generating a sending alias email address and creating a database record including the sender's email address, the generated sending alias email address, the protected entity delivery address and the receiving alias email address.

5. A method comprising:
receiving an instruction to send an email message from an unprotected sending contact entity to a receiving alias email address relating to a protected receiving contact entity;
identifying a database record containing the receiving alias email address in a ‘receiving alias’ field;
extracting a protected entity delivery email address for the protected receiving contact entity from a ‘protected entity delivery address’ field of the database record;
extracting a sending alias email address for the unprotected sending contact entity from a ‘sending alias’ field of the database record;
populating the sending alias email address in the envelope sender field of the email message;
populating the protected entity delivery email address in the envelope recipient field of the email message; and
sending the email message with the populated envelope sender and envelope recipient fields.

6. A method as claimed in claim 5, comprising substituting instances of the email address of the unprotected sending contact with the sending alias email address in two or more or all fields of the email message in which the email address of the unprotected sending contact is present.

7. A method as claimed in claim 5, comprising substituting instances of the receiving alias email address with the protected entity delivery email address in two or more or all fields of the email message in which the receiving alias email address is present.

8. A method comprising:
receiving either a) an email message or b) an instruction to send an email message at a service provider, the email having in an envelope sender field a sender's email address relating to a protected sending contact entity and in an envelope recipient field a sending alias email address relating to an unprotected receiving contact entity;
wherein the sending alias email address includes a domain that is controlled by the service provider such that the email message is addressed to the unprotected receiving contact entity via the service provider,
identifying a database record containing the sending alias email address and the sender's email address;
extracting from the database record an unprotected entity delivery email address for the unprotected receiving contact entity;
extracting from the database record a receiving alias email address for the protected sending contact entity, the receiving alias email address identifying a domain that is controlled by the service provider;
indicating the receiving alias email address as the email address of the sender of the email message; and
providing the email message with the substituted sender email to the unprotected receiving contact entity.

9. A method as claimed in claim 8,
wherein indicating the receiving alias email address as the email address of the sender of the email message comprises substituting the sender's email address in the envelope sender field of the email message with the receiving alias email address,
wherein the method comprising substituting the recipient's email address in the envelope recipient field of the email message with the unprotected entity delivery email address, and
wherein providing the email message with the substituted sender email to the unprotected receiving contact entity comprises sending the email message with the substituted envelope sender and envelope recipient email addresses.

10. A method as claimed in claim 8, comprising substituting instances of the sender's email address with the receiving alias email address in two or more or all fields of the email in which the sender's email address is present.

11. A method as claimed in claim 8, comprising substituting instances of the recipient's email address with the unprotected entity delivery email address in two or more or all fields of the email in which the recipient's email address is present.

12. A method comprising:
receiving an instruction to send an email message at a service provider, the email having in an envelope sender field a sender's email address relating to a protected sending contact entity and in an envelope recipient field an email address relating to an unprotected receiving contact entity;
identifying a database record containing both the email address relating to the unprotected receiving contact entity and the sender's email address;
extracting from the database record a receiving alias email address for the protected sending contact entity, the receiving alias email address identifying a domain that is controlled by the service provider;
indicating the receiving alias email address as the email address of the sender of the email message; and
providing the email message with the substituted sender email to the unprotected receiving contact entity.

13. A method as claimed in claim 12, comprising maintaining at the service provider a database comprising plural records, each record comprising a sending alias email address, a receiving alias email address, a protected entity email address, and a delivery email address, wherein each of the sending alias email address and the receiving alias email address include a domain that is controlled by the service provider.

14. A method comprising:
receiving an email message at a service provider, the email having in an envelope sender field a sender's email address relating to a protected sending contact entity and in an envelope recipient field a sending alias email address relating to a protected receiving contact entity, wherein the sending alias email address includes a domain that is controlled by the service provider such that the email message is addressed to the protected receiving contact entity via the service provider;
identifying a first database record containing both the sending alias email address in a ‘sending alias’ field and the sender's email address in a ‘protected entity delivery address’ field;
extracting from a ‘contact entity delivery address’ field of the first database record a protected entity delivery email address for the protected receiving contact entity;
extracting from a ‘receiving alias’ field of the database record a receiving alias email address for the protected sending contact entity, the receiving alias email address identifying a domain that is controlled by the service provider;
identifying a second database record containing both the protected entity delivery email address in the ‘receiving alias’ field and the receiving alias email address in the ‘contact entity delivery address’ field;
extracting from the ‘protected entity delivery address’ field of the second database record a protected entity delivery email address for the protected receiving contact entity;
substituting the recipient's email address in the envelope recipient field of the email message with the protected entity delivery email address from the second database record; and
substituting the sender's email address in the envelope sender field of the email message with an alias email address from the second database record; and
sending the email message with the substituted envelope sender and envelope recipient email addresses.

15. A method as claimed in claim 14, further comprising:
extracting from the ‘sending alias’ field of the second database record a sending alias email address for the protected sending contact entity, the sending alias email address identifying a domain that is controlled by the service provider; and
substituting the sender's email address in the envelope sender field of the email message with the sending alias email address from the second database record.

16. A method as claimed in claim 14, wherein substituting the sender's email address in the envelope sender field of the email message comprises substituting with the receiving alias email address for the protected sending contact entity.

17. A method comprising:
receiving an instruction to send an email message at a service provider, the email having in an envelope sender field a sender's email address relating to a protected sending contact entity and in an envelope recipient field a receiving alias email address relating to a protected receiving contact entity, wherein the receiving alias email address includes a domain that is controlled by the service provider such that the email message is addressed to the protected receiving contact entity via the service provider;
identifying a first database record containing both the receiving alias email address in a ‘contact entity delivery address’ field and the sender's email address in a ‘protected entity delivery address’ field;
extracting from a ‘receiving alias’ field of the database record a receiving alias email address for the protected sending contact entity, the receiving alias email address identifying a domain that is controlled by the service provider;
identifying a second database record containing both the contact entity delivery email address in the ‘receiving alias’ field and the receiving alias email address in the ‘contact entity delivery address’ field;
extracting from the ‘protected entity delivery address’ field of the second database record a protected entity delivery email address for the protected receiving contact entity;
substituting the recipient's email address in the envelope recipient field of the email message with the protected entity delivery email address from the second database record; and
substituting the sender's email address in the envelope sender field of the email message with an alias email address from the second database record; and
sending the email message with the substituted envelope sender and envelope recipient email addresses.

18. A method as claimed in claim 17, further comprising:
extracting from the ‘sending alias’ field of the second database record a sending alias email address for the protected sending contact entity, the sending alias email address identifying a domain that is controlled by the service provider;
substituting the sender's email address in the envelope sender field of the email message with the sending alias email address from the second database record; and
sending the email message with the substituted envelope sender and envelope recipient email addresses.

19. A method as claimed in claim 17, wherein substituting the sender's email address in the envelope sender field of the email message comprises substituting with the receiving alias email address for the protected sending contact entity.

20. A method comprising addressing an email to an email address comprising:
a user name,
a sub-domain name,
a top level domain, and
a second level domain,
wherein the user name and the sub-domain name are separated by an “@” character,
wherein the sub-domain name and the second level domain are separated by a first “.” character,
wherein the second level domain and the top level domain are separated by a second “.” character, and
wherein the sub-domain name identifies an authorized sender of the message.

21. The method of claim 20, comprising sending the email to the email address.

22-25. (canceled)

26. A method as claimed in claim 1, comprising substituting instances of the email address of the unprotected sending contact with the sending alias email address in two or more or all fields of the email message in which the email address of the unprotected sending contact is present.

27. A method as claimed in claim 1, comprising substituting instances of the receiving alias email address with the protected entity delivery email address in two or more or all fields of the email message in which the receiving alias email address is present.

28. A method as claimed in claim 8, comprising maintaining at the service provider a database comprising plural records, each record comprising a sending alias email address, a receiving alias email address, a protected entity email address, and a delivery email address, wherein each of the sending alias email address and the receiving alias email address include a domain that is controlled by the service provider.
